(19) United States
(12) Patent Application Publication
(10) Pub. No.: US 2005/0194356 A1
(43) Pub. Date: Sep. 8, 2005

(54) Removing photoresist from a workpiece using water and ozone and a photoresist penetrating additive

(75) Inventor: Eric J. Bergman, Kalispell, MT (US)

Correspondence Address: PERKINS COIE LLP/SEMITOOL, PO BOX 1208, SEATTLE, WA, 98111-1208, US

(73) Assignee: Semitool, Inc.

(21) Appl. No.: 11/111,041

(22) Filed: Apr. 21, 2005

Related U.S. Application Data
(63) Continuation-in-part of application No. 09/621,028, filed on Jul. 21, 2000, now Pat. No. 6,869,487.
Application No. 09/621,028 is a continuation-in-part of application No. PCT/US99/08516, filed on Apr. 16, 1999.
Application No. PCT/US99/08516 is a continuation-in-part of application No. 09/061,318, filed on Apr. 16, 1998, now abandoned.
Application No. 09/061,318 is a continuation-in-part of application No. 08/853,649, filed on May 9, 1997, now Pat. No. 6,240,933.
(63) Continuation-in-part of application No. 09/925,884, filed on Aug. 6, 2001.
(63) Continuation-in-part of application No. 10/870,173, filed on Jun. 18, 2004.
(63) Continuation-in-part of application No. 10/917,094, filed on Aug. 11, 2004.
(63) Continuation-in-part of application No. 11/005,495, filed on Dec. 6, 2004.
(60) Provisional application No. 60/145,350, filed on Jul. 23, 1999.
(60) Provisional application No. 60/099,067, filed on Sep. 3, 1998.
(60) Provisional application No. 60/125,304, filed on Mar. 19, 1999.

(51) Int. Cl. C23F 1/00; C03C 25/68; B08B 9/00

(52) U.S. Cl. 216/83; 438/725; 134/22.1; 156/345.11

(57) ABSTRACT

Photoresist is quickly removed from a wafer using a process liquid including water, ozone and a photoresist penetrating additive, such as ammonium hydroxide. The penetrating additive creates cracks in the photoresist layer. The process liquid moves through the cracks and etches away the underlying adhesion layer. The photoresist layer is then released from the wafer. Pieces or particles of the photoresist are lifted off of the workpiece and carried away in a flow of the liquid.

This Application is a Continuation-in-Part of U.S. patent application Ser. No. 09/621,028, filed Jul. 21, 2000 and now pending, which is a Continuation-in-Part of International Patent Application PCT/US99/08516, which is a Continuation-in-Part of U.S. patent application Ser. No. 09/061,318, filed Apr. 16, 1998 and now abandoned, which is a Continuation-in-Part of U.S. patent application Ser. No. 08/853,649, filed May 9,1997, now U.S. Pat. No. 6,240,933.

U.S. patent application Ser. No. 09/621,028 also claims priority to U.S. Patent Application No. 60/145,350, filed Jul. 23, 1999.

PCT/US99/08516 claims priority to U.S. Patent Application Nos. 60/099,067 filed Sep. 3, 1998 and 60/125,304 filed Mar. 23,1999.

This Application is also a Continuation-in-Part of U.S. patent application Ser. Nos. 09/925,884, filed Aug. 7, 2001; Ser. No. 10/870,173 filed Jun. 18, 2004; Ser. No. 10/917,094, filed Aug. 11, 2004; and Ser. No. 11/005,495 filed Dec. 6, 2004, all now pending. Each of the applications listed above is incorporated herein by reference.

### FIELD OF THE INVENTION

Semiconductor devices are the basic building blocks of most electronic products. They are widely used in an ever expanding array of products. Semiconductor devices are generally manufactured on a microscopic scale on semiconductor material wafers, or other substrates, via photoithography. This process involves multiple etching, metal or chemical deposition, and chemical treatment steps. In a typical lithography procedure for manufactureing a microelectronic device, a layer of conductive metal several nanometers thick is deposited onto the substrate. A layer of photoresist is applied on top of the metal layer. Photoresist is typically a liquid chemical that hardens when exposed to UV light. The photoresist is selectively hardened by illuminating it at specific locations with UV light passing through a patterned mask. The photoresist not exposed to UV light is not hardened and is etched away (along with the metal under it) in a susequent chemical process step. Additional plating and etching steps may follow. The hardened photoresist is eventually etched away in a later process step. This leaves a metal layer on the substrate in the same pattern as the mask (although on a microscopic scale). In complex microcircuits, this process may be repeated many times, building up layer upon layer of microscopic metal elements, which form microelectronic or other micro-scale components, and/or interconnections between them. In addition to manufacturing microelectronic and semiconductor devices, photoresist is also used in generally similar ways in biomedical engineering, holographic, and nano-technology devices.

Novalak resin types of photoresist (also referred to as 248 nm photoresists) have been used for many years. These types of photoresist (after hardening via ultraviolet light with a 248 nm wavelength) were conventionally removed using large quantities of etching chemicals, such as acids, in multiple step immersion processes. While successful in removing the hardened photoresist, these immersion processes were time consuming, expensive, subject to variable results, and generated large amounts of chemical waste.

In a technological breakthrough made several years ago, the present inventor developed a vastly improved technique for removing photoresist. This new Hydrozone™ technique requires only use of ozone and water, while outperforming virtually all other techniques in photoresist removal speed and effectiveness. The Hydrozone process has since met with widespread commercial success, public acclaim, and has been frequently emulated by others. The Hydrozone process is also the subject of several pioneering patents, including U.S. Pat. Nos. 6,701,941, 6,273,108, 6,601,594, and others.

The Hydrozone process is extremely effective in removing 248 nm photoresists. The molecular structure of these types of photoresists typically has double bonds. It is generally believed that these double bonds serve as primary attack sites for the ozone to initiate bond cleavage and the breakdown of the photoresist polymer chain.

In recent years, newer photoresists, known as 193 nm photoresists, have become more common in the semiconductor and related industries, to better meet the manufacturing needs of making ever smaller devices. These 193 nm photoresists use a different base resin, typically called methacrylate or polymethacrylate resin, which does not have a double bond structure. Unlike the 248 nm photoresists, the 193 nm photoresists are not easily removed using the water and ozone processes. Accordingly, there is a need for improved technology for removing photoresist, and similar coatings.

### SUMMARY OF THE INVENTION

Photoresists, anti-reflective coatings, and similar organic coatings or layers are effectively removed using a liquid solution of water, a coating penetrating additive, and ozone. In one form of the process, the coating penetrating additive creates cracks or openings in the coating. This allows the solution to etch an underlying layer and remove the coating. Ammonia works well as an additive for removing photoresist.

This process may be performed in a wide range of processing systems. Examples of processing systems are shown in the drawings.

The invention resides as well in sub-combinations of the methods and apparatus described. Features or elements described in connection with one embodiment may be used in other embodiments as well.

### BRIEF DESCRIPTION OF THE DRAWINGS

FIG. 1 is a perspective view of an automated system for performing photoresist removal processes in a single wafer or workpiece processing mode.

FIG. 2 is a plan view (looking down through the top of the enclosure) of the system of FIG. 1.

FIG. 3 is a perspective view of one of the single wafer processors shown in FIG. 2.

FIG. 4 is a perspective view of the bowl or base of the processor shown in FIG. 3.

FIG. 5 is a section view of the base shown in FIG. 4.

FIG. 6 is a schematic view of a system for performing photoresist removal on batch of workpieces.

FIG. 7 is a schematic view of a system for performing photoresist removal using steam.

### DETAILED DESCRIPTION

Overview.

Photoresist and similar coatings or layers are removed from a workpiece using a process liquid including water, ozone, and a penetrating chemical additive, such as ammonia, that promotes the creation of cracks or openings in the photoresist. The process liquid penetrates through the cracks and gets between the photoresist layer and the next underlying film or layer. The underlying film or layer, which may be an adhesion layer, is etched by the process liquid. The photoresist is released from workpiece and is removed or lifted off the workpiece by fluid, inertial, centrifugal, and/or other forces. The penetrating chemical also induces stresses in the layer, which helps to remove the layer. Photoresist here means any layer of organic material applied to and then subsequently removed from a workpiece, in the manufacturing process. Workpiece means a silicon wafer or other substrate used in manufacturing of semiconductor devices, memory disks, photo-masks, optical devices, and other substrates on which micro or nano electronic, micro or nano optical, micro or nano mechanical, or micro or nano-electromechanical devices can be or are formed (collectively referred to here as “workpieces” or “wafers”).

The chemical additive may be ammonium hydroxide, ammonium fluoride, an organic amine, or an alkali or alkaline earth hydroxide. Other additives as well may also provide for the cracking or penetration of the resist film, to allow the process liquid to chemically react with and remove an underlying film, and lift off the photoresist. The methods may be performed in either batch or single-wafer processing platforms. The process may be performed in immersion, spray or steam modes as well.

The process applies to various types of photoresist. Relative to 193 nm photoresists, testing shows that many of the different 193 nm photoresists can be removed using ozone and water with ammonium hydroxide. The ammonium hydroxide appears to crack the surface of the photoresist. This opens a physical pathway through the photoresist to the underlying layer. The process liquid is then able to penetrate through the cracks and etch away the underlying layer. The underlying layer is often an adhesion promoting film such as HMDS, which is rapidly etched by ozone and water. As a result, 193 nm photoresists can be removed via a “lift-off” process. When the lift off process is carried out, the photoresist itself may not be significantly etched, so that the thickness of the photoresist may not change. Rather, in the lift off process, the photoresist may be lifted off of the workpiece, in particles, flakes or pieces ranging in size, for example, from microscopic up to about 1-10 or 2-8 mm (largest dimension).

A surfactant may be added to the process liquid to aid in liquid penetration through small cracks or openings in the photoresist layer. Corrosion inhibitors (other than ammonium hydroxide which itself can act as a corrosion inhibitor) may also be used. HF and/or HCl, or other acids, may be used as additives for removal of other organic contaminants, particles and/or metals, or for removal of oxide and regeneration of a controlled chemical oxide. After processing, the wafers may be rinsed and dried using known techniques.

Process Temperatures.

For most applications of the present methods, the liquid is heated to an above ambient temperature. In methods where the ozone is injected into the liquid, heating the liquid may be performed before the ozone is injected, to reduce the amount of ozone breakdown in the liquid In these versions of the present methods, typically due to the larger amounts of ozone injected into the liquid and the low solubility of the ozone gas in the heated liquid, the liquid will contain some dissolved ozone, as well as entrained macroscopic or microscopic ozone bubbles. The ozone gas may be both provided as a dry gas directly into the process chamber, and also introduced into the liquid before the liquid is delivered into the process chamber.

Generally, process liquid temperatures from about 25, 30, 35, 40 or 45 C up to about 75, 80, 85, 90, 95 or 99 C are used. Higher temperatures promote faster removal rates. However, to reduce or avoid corrosion off underlying materials, lower temperatures may be used. In addition, unlike conventional photoresist removing processes, here, the fastest removal rate may not always be desired. Removing the photoresist very quickly can lead to sudden release of large pieces or sheets of photoresist, resulting in pieces of the photoresist re-depositing on the workpiece or on surfaces of the process apparatus, where it can be very difficult to remove. In these cases, a slower removal rate can be beneficial, and may be achieved through lower temperatures.

Additive Concentrations.

Ammonia is typically supplied in a 30% by weight solution of ammonia (NH3) in water. This is diluted in the process liquid. The dilutions are given in volumetric ratios. 2000:1, for example, is 2000 parts by volume of water mixed with 1 part by volume of 30% NH3 in water, or an NH3 concentration of 0.015% by weight. If the ammonia concentration is too high, it can lead to pitting of the workpiece surface. The specific dilution of ammonia used is dependent on temperature. Higher temperatures increase chemical reactivity and therefore require a lower ammonia concentration. At 90 C, a typical dilution ranges from 4000:1 to 500:1, and more typically in a range of 2500:1 to 1000:1. At ambient temperature of 20 C, concentrations in the range of 1000:1 to 100:1, and more typically 600:1 to 200:1, may be used. As with temperature, a concentration of ammonia that gives a slower removal of the photoresist may be used, to minimize the potential for redeposition of photoresist particles on the workpiece or the process apparatus. Slower processing achieves more fracturing of the photoresist. With more fracturing, the photoresist comes off in smaller pieces, reducing the potential for redeposition. In many applications, the additive with be a chemical which can be at least partially absorbed by the layer, to help to introduce stress in the layer, resulting in cracking.

Flow Rates.

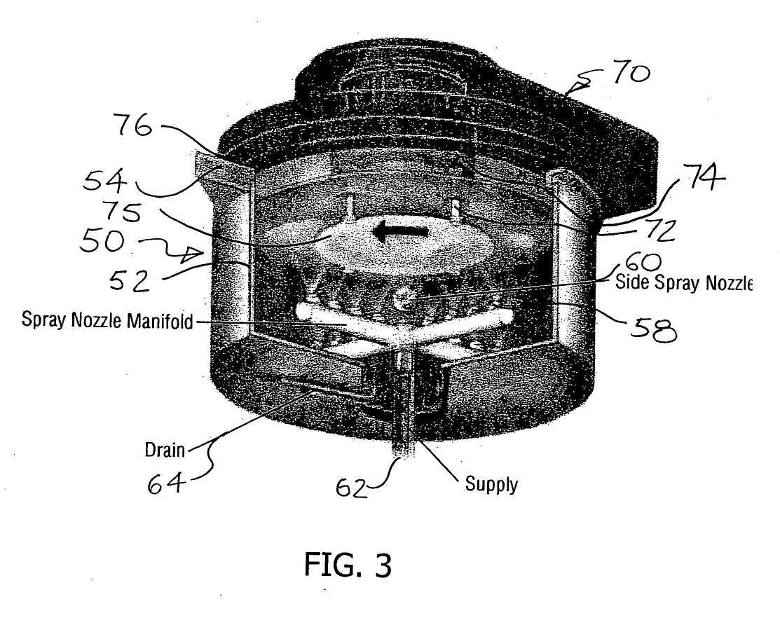

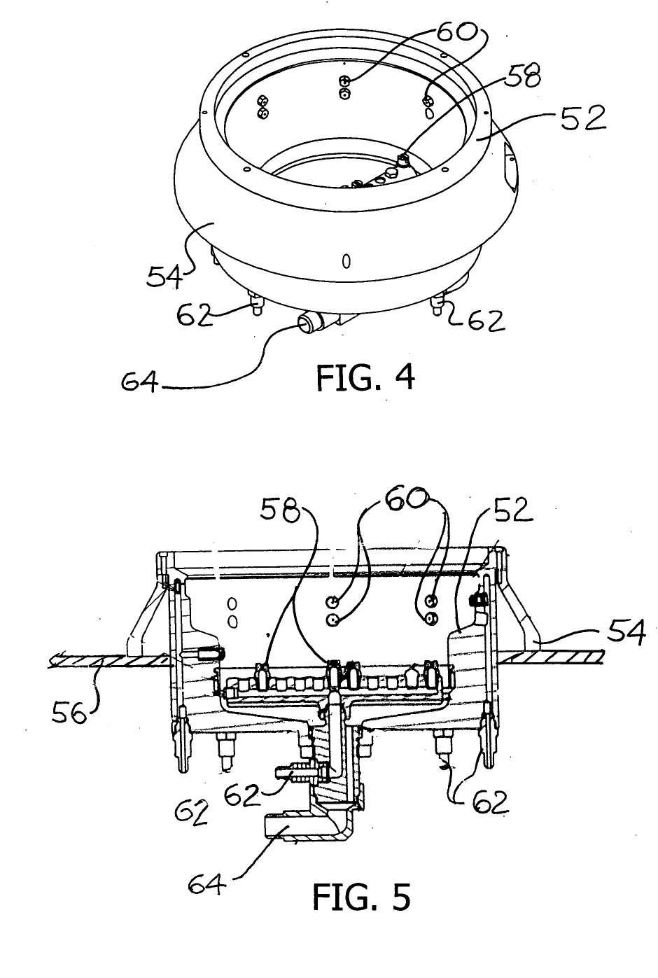

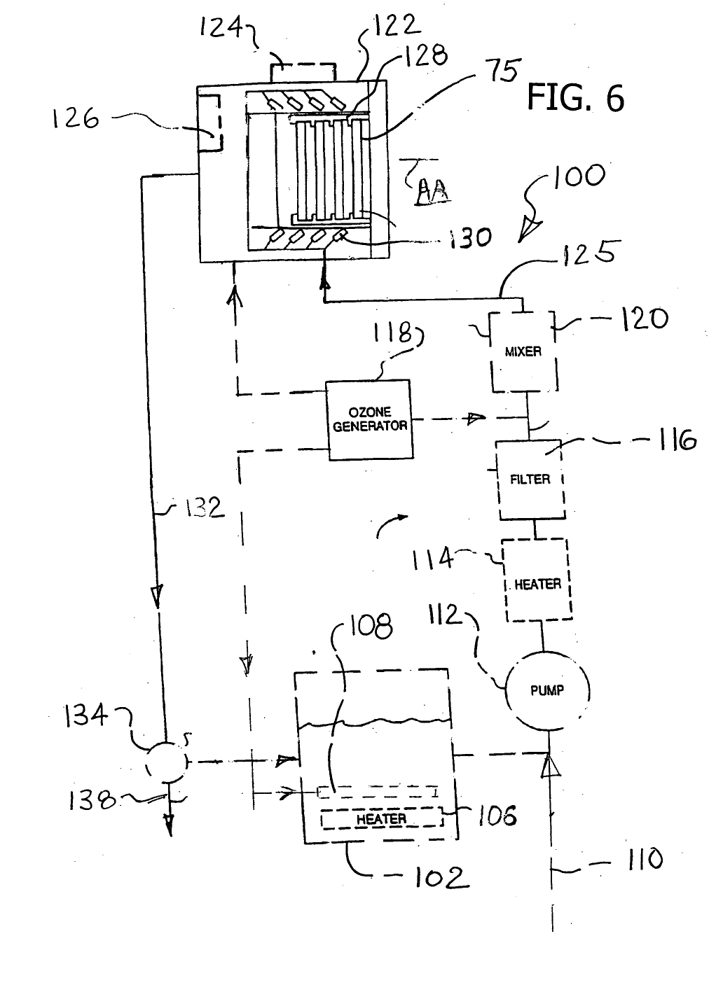

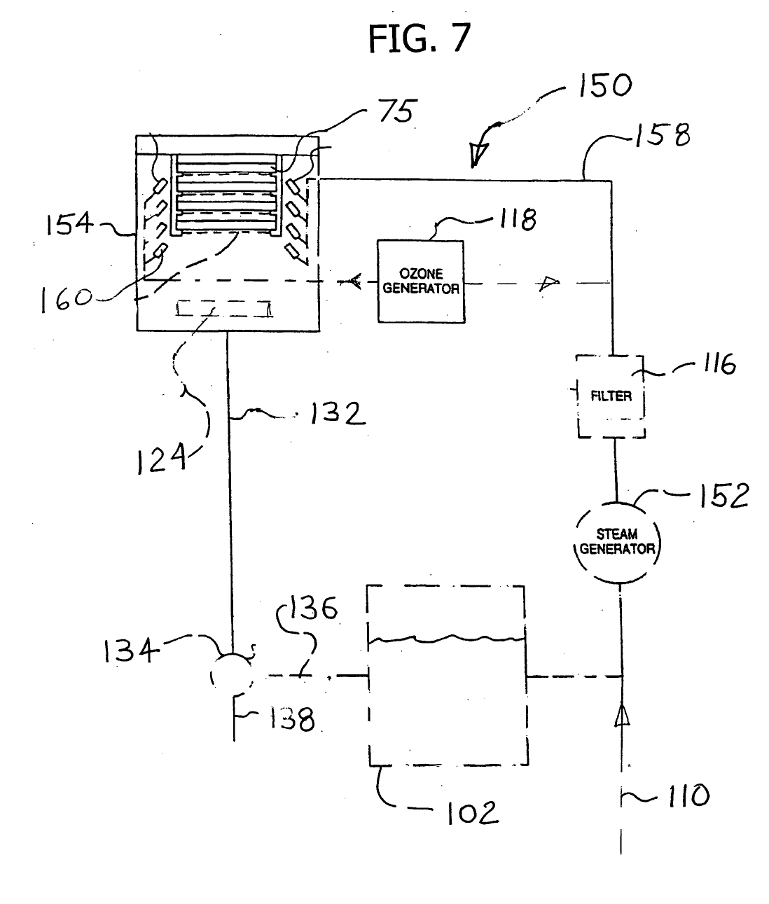

Single wafer processors, for example as shown in FIGS. 3 and 4, may run at process liquid flow rates in the range of 500 ml to 2000 ml per minute. A 25 wafer batch tool, for example as shown in FIG. 6, will generally run in the range of 3 to 10 lpm, and a 50 wafer batch tool will run in the range of 4 to 12 lpm. Higher flows may be useful for slowing and controlling the removal of the photoresist, and for flushing the surface thoroughly to prevent redeposition and keep lifted particles entrained in the fluid stream. These flow rates contemplate a spray process. However, the present process may also be performed as an immersion process, by immersing the workpieces into a bath of water and a penetrating additive, in the presence of ozone. In this approach, the ozone may be provided as a submerged jet of gas across the surface of the immersed workpiece. Ozone bubbles deliver ozone to the workpiece, and may also provide some mechanical surface scrubbing or actuation. The workpieces may advantageously be oriented between horizontal and vertical while immersed, e.g., at an angle to vertical ranging from about 10, 20 or 30 degrees to about 60, 70 or 80 degrees, with about 40, 45 or 50 degrees as a nominal orientation.

Spin Speeds.

Test results show that rotation speed (RPM) is not as significant to the removal or lift off in a 193 nm process as it is in the oxidation of 248 nm resist. For example, 193 nm photoresist has been removed or lifted off using spin speeds in the range of 25 to 2000 RPM, with demonstrated success at both extremes. Higher RPM may be useful in generating centrifugal force to shear lifted particles from the surface, while lower RPM allows the liquid stream to flush the surface more thoroughly. The spin speed may be cycled between high speeds and low speeds, to achieve both the shearing and the flushing actions. The process, may also be performed without spinning. If the workpiece(s) is stationery, the same steps are performed, except spraying or another technique is used to carry away pieces and particles of the layer.

ARC Removal.

As described in U.S. Provisional Patent Application Serial No. 60/125,304, anti-reflective coatings (ARC) can be removed using only water and ozone. However, this is a relatively slow process (for example, with little or no ARC removal after 3 minutes and significant removal only after 6 minutes). Use of ammonia with water and ozone, as described above, can expedite ARC removal. Higher concentrations of ammonia will lead to a lift-off of the ARC, in a way similar to lift off of photoresist.

Many workpieces have both a photoresist edge bead rings and an ARC edge bead ring. Testing shows the ARC edge bead ring is more difficult to remove than the photoresist. The ARC edge bead can be removed at a lower ammonia concentration of about 1660:1, with risk of pitting the workpiece avoided.

Example of Process Steps.

Optimized process steps, in terms of time durations, temperatures, spin speeds, concentrations, etc, will vary depending on the types of photoresists and/or other layers to be removed. The specific steps outlined in the table below are of one process that works well for removing 193 nm photoresist.

| Step | Time (Min.) | RPM | Function |
|---|---|---|---|
| 1 | 1:00 | 100 | Convert the surface to hydrophilic. Hot |
| | | | DI water and ozone, 100 rpm |
| 2 | 3:00 | 25 | Hot DI water, ozone and NH4OH 2.5 |
| | | | ml/min to fracture photoresist without |
| | | | excessive sloughing off |
| 3 | 3:00 | 800 | Hot DI water, ozone, and NH4OH 2.5 |
| | | | ml/min to remove fractured photoresist |
| 4 | 1:00 | 25 | Hot DI water, ozone, clocking, flush |
| | | | surface |
| 5 | 3:00 | 800 | Same as step 3 |
| 6 | 1:00 | 25 | Same as step 4 |
| 7 | 3:00 | 800 | Same as step 3 with NH4OH increased |
| | | | to 4 ml/min to attack edge bead |
| 8 | 1:00 | 25 | Same as step 4 |
| 9 | 3:00 | 800 | Same as step 7 |

This process may be concluded with a short sequence of DI water rinse steps and then a spin dry.

Process Systems (Single Wafer).

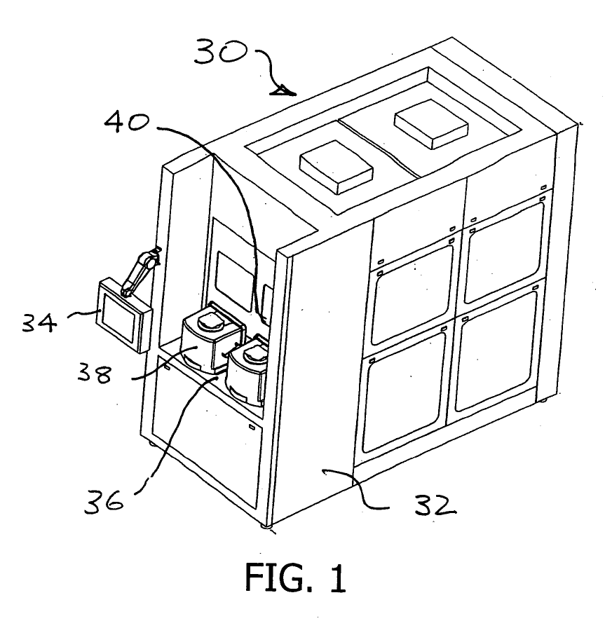

The processes may be performed in wide range of different systems or processors. FIGS. 1-7 show representative examples of systems that may be used. Since the processes are largely independent of the systems and processors, and vice versa, the following discussion of systems and processors is not intended to affect the description of the processes provided above.

FIGS. 1-5 show a single wafer processing system 30. As shown in FIG. 1, the system 30 is typically contained within an enclosure 32, and may be monitored and controlled or programmed by a user control panel/display 34. Containers 38 holding workpieces or wafers 75 are placed at a load/unload station 36. Workpieces are moved into the system via ports or windows 40, which may be located at a container docking station, for example as described in U.S. Pat. Nos. 6,447232; 6,273,100; 6,279,724; 6,014,817; 6,871,655, or U.S. patent application Ser. No. 09/612,009, each incorporated herein by reference.

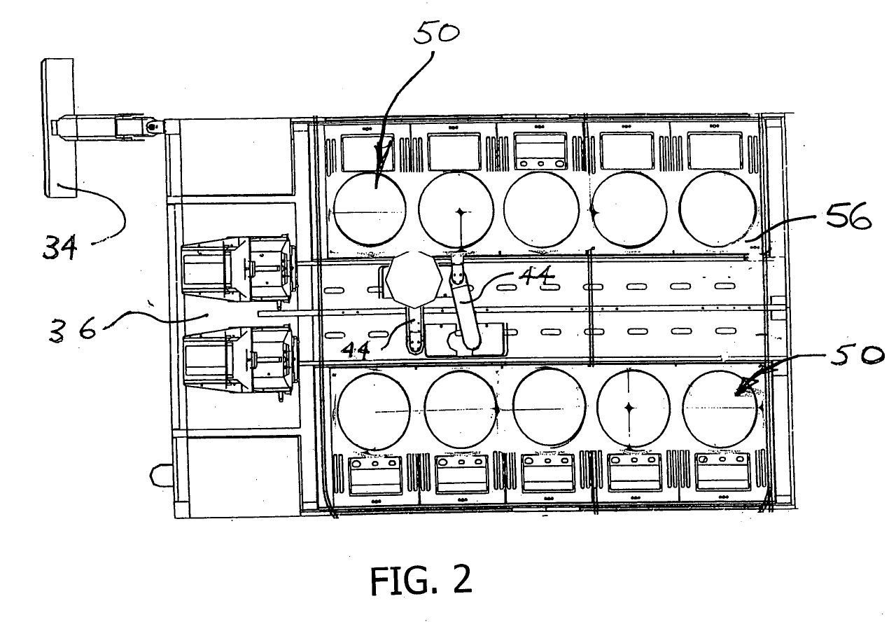

As shown in FIG. 2, the system 30 shown may have two parallel rows or arrays of processors 50 supported on a deck 56 within the enclosure 32. A robot 44 may be provided to move workpieces 75 into and out off the processors 50. Of course, other arrangements of one or more processors can also be used. While FIGS. 1 and 2 show an automated system having several processors, manual systems, and a system with only a single processor 50 may also be used.

Details of an example of a processor 50 are shown in FIGS. 3-5. Processors of various designs may be used to perform the methods of the invention. FIGS. 1-5 show one system and processor design, as an example. Referring to FIGS. 3-5, the processor 50 has a head 70 and a bowl 52. The bowl 52 has a mounting ring 54 which attaches the bowl 52 to the deck 56. Lower spray nozzles 60 are directed to spray upwardly towards a workpiece 75 held on the head 70. The nozzles 60 may be on a rotating or fixed spray bar or manifold. Side spray nozzles 60 are positioned to spray radially inwardly on the workpiece 75. The spray nozzles 58 and 60 may be megasonic or ultrasonic nozzles, or they may be conventional liquid, gas or steam spray nozzles. The nozzles 58 and 60 are supplied with liquid from one or more liquid inlets 62. Used liquid is removed from the bowl 52 via a liquid drain 64.

The head 70 is moved into engagement on the bowl via a head lifter (not shown) which optionally can also invert, for loading and unloading a workpiece. A rotor 74 has workpiece holders 72 that hold the workpiece by the edges. The rotor 74 spins the workpiece 75 during processing. A seal may be provided on the bowl or head, to reduce or prevent escape of liquids or gases from the bowl 52 during processing.

Test Results.

Example I below describes removal of photoresist in a single wafer processing system similar to the system of FIGS. 1-5.

### EXAMPLE I

In a single-wafer processing system, as generally described in U.S. patent application Ser. No. 10/691,688, incorporated herein by reference, and as generally shown in FIGS. 1-5, the following process was performed: An HMDS layer was applied to silicon wafers. A 193 nm photoresists (IL5420 manufactured by Arch Chemicals Corporation, Norwalk, Conn., USA) was applied over the HMDS layer, as a bi-layer resist. A top anti-reflective coating (TARC or top ARC layer) was then applied onto the photoresist. The TARC layer was AQUATAR6, a Fluoroalkylsulfonic acid (manufactured by AZ Electronic Materials, Inc., Somerville, N.J., USA).

The wafers were 9k blanket SiCOH with 2k blanket TEOS on top. The resist was patterned and developed normally, however there was no etch performed (blanket photoresist). The wafers were processed with 1000:1 diluted NH4OH for 60, 120, and 600 seconds (i.e., diluting one part of the 30% by weight ammonia in water solution with 1000 parts of water). Both the 120 and 600 second wafers were completely clear while the 60 second wafer was not. RPM was varied between 50 and 2000 RPM and complete removal of the photoresist and ARC was achieved.

The combination of water, ozone and ammonium hydroxide effectively removed both blanket 193 nm photoresist films as well as patterned 193 nm photoresist. Inspection of wafers from earlier tests on which the resist had been partially removed showed resist residue thickness to be in integer multiples of the starting photoresist thickness—that is 1×, 2× or 3× the initial photoresist thickness measurement. Microscope inspection showed very distinct lines of demarcation along the resist removal plane. This means that the resist did not appear to be oxidized or thinned. Rather, the resist was either entirely present or completely gone. The multiples of the resist thickness appear to be due to fragments of photoresist lifting off and either folding over on top of or redepositing on top of the bulk resist film, thereby giving 2× or 3× the starting thickness measurement. The lift-off removal is believed to be due to the oxidative attack of the underlying adhesion promoter, typically HMDS. Either the elevated pH due to the presence of the hydroxyl ion, or the cracking of the resist due to the presence of the ammonium ion, is the primary factor which makes this process work. However, it may also be that both of these factors are necessary.

Process Systems (Batch)

FIGS. 6 and 7 show batch processing systems. As shown in FIG. 6, in a basic form, a batch of workpiece 75 are held within a process chamber 122. A process liquid including DI water, ozone and ammonia is applied onto the workpieces, typically by spraying. The workpieces 75 are advantageously rotated in a rotor 128.

Various system components may be used to supply the process liquid. FIG. 6 shows one example. In FIG. 6, a process liquid 104, such as DI water, is contained in a tank 102. A tank heater 106 is optionally provided to heat the liquid in the tank. A pump 112 pumps the liquid into the process chamber 122. An in-line liquid heater 1124 a filter 116 and a mixer 120 may be placed in the liquid delivery line 125 connecting to the process chamber 122. The heaters 106 and/or 114 are used to heat the process liquid. The process liquid may alternatively be supplied by a factory supply 110, in place of the tank 102 and/or the pump 112.

An ozone generator 118 generates ozone and supplies ozone to one or more of the process chamber 122, to a diffuser 108 in the tank 102, and/or to the liquid delivery line 125. These alternative ozone supply paths are shown in dotted lines in FIG. 6. One or more of them may be used. Another alternative is to have ozone supplied with process liquid from the factory supply line 110, with or without also using the ozone generator 118. If ozone is supplied from the ozone generator 118 into the liquid delivery line 125, then an in-line mixer 120 may be used to better mix the ozone gas and the process liquid.

Many different designs may be used for the process chamber 122. In the example shown in FIG. 6, the chamber 122 may includes a chamber heater 124, a UV light source 126 and spray nozzles 130 for spraying process liquid onto the workpieces 75. The workpieces can also be heated directly via conduction heaters on the rotor 128. The chamber heater 124 heats the chamber 122 or 154 which in turn heats the workpieces. Ozone gas may also be sprayed towards the workpieces, from the nozzles 130, or from separated dedicated gas spray nozzles supplied with ozone from the ozone generator 188. A drain line 132 drains used liquid from the chamber 122. A recirculation valve 134 may be used to recirculate used liquid back into the tank 102, or to direct the used liquid into a factory waste drain 138.

Tests were run in a batch processing system, similar to the single wafer system tests described above. The batch processing system used was similar to the system described in U.S. patent application Ser. No. 10/654,849, incorporated herein by reference, and similar to system shown in FIG. 6. Batches of 300 mm wafers were coated with T4181 photoresist (from Brewer Science Corporation, Rolla, Mont., USA) and with the ARC29A BARC coating. Similar test results were observed.

FIG. 7 shows a batch processing system 150 similar to the system shown in FIG. 6, but set up to process with steam instead of liquid. In FIG. 7, liquid, such as DI water, including ammonia is supplied to steam boiler or generator 152. The steam generator 152 supplies steam to nozzles 160, or other openings, in a process chamber 154. The chamber, 154 may be pressurizable. An ozone generator supplies ozone gas into the steam delivery line 158, or directly into the process chamber 154, or both. Process temperatures above 95 C, and above 100 C, may be used either in a steam process using a pressurized process chamber, or in a liquid process using a pressurized chamber. In these processes, temperatures up to 200 C may be used through appropriate pressurization. Steam processes can of course also be carried out in single wafer processors.

In the systems shown in FIGS. 1-7, the spray or other application of liquid or steam (or ozone gas) may be directed to the upper surface of the workpiece 20 or the lower surface, or both. The liquid may also be applied in other ways besides spraying, such as flowing, bulk deposition, immersion, etc. The liquid may also be applied as one or more high pressure jets, as described in U.S. patent application Ser. No. 09/925,884, incorporated herein by reference. In each of the systems shown in FIGS. 1-7, the ozone gas may be separately sprayed, jetted, or entrained in a carrying liquid or gas or steam, or otherwise introduced as a gas into the process chamber, where it can diffuse or dissolve into the liquid. In general however, the ozone will more typically be dissolved or entrained into the liquid before the liquid is supplied into the process chamber.

Thus, novel method and systems have been shown and described. Various changes and substitutions can of course be made, without departing from the spirit and scope of the invention. The invention, therefore, should not be limited, except by the following claims and their equivalents.

1. A method for removing photoresist from one or more workpieces, comprising:
placing the workpiece into a chamber;
applying a liquid onto the workpiece, with the liquid including water, ozone and a photoresist cracking element; and
spinning the workpiece within the chamber.

2. The method of claim 1 with the liquid comprising water and the cracking element comprising ammonium hydroxide at a concentration of water to ammonium hydroxide ranging from about 500:1 to 4000:1.

3. The method of claim 1 further comprising heating one or more of the liquid, the workpiece, and the chamber.

4. The method of claim 1 further comprising adding a surfactant to the liquid.

5. The method of claim 1 where the liquid is applied to the workpiece by spraying the liquid onto the surface of the workpiece at a controlled flow rate.

6. A method for removing photoresist and an adhesion layer from a surface of a workpiece, comprising:
applying a heated liquid onto a surface of the workpiece having a coating of photoresist, with the liquid including water, ozone, and a photoresist penetrating additive;
creating openings in the photoresist via chemical reaction between the photoresists and the penetrating additive, and with the liquid flowing through the openings and contacting the adhesion layer;
etching the adhesion layer; and
lifting off pieces of the photoresist layer from the workpiece.

7. The method of claim 6 with the liquid heated to about 30-100 C.

8. The method of claim 6 where the openings comprise cracks in the photoresist layer formed via chemical reaction of the additive and the photoresist layer.

9. The method of claim 6 wherein the penetrating additive comprises ammonium hydroxide at a water to ammonium hydroxide concentration of ranging from about 500:1 to 5000:1.

10. The method of claim 6 where the photoresist is a 193 nm photoresist.

11. The method of claim 6 further comprising spinning the workpiece.

12. The method of claim 1 where the photoresist penetrating additive comprises ammonium hydroxide, tetra-methyl ammonium hydroxide (TMAH), KOH or NaOH.

13. A system for removing photoresist from a workpiece, comprising:
a process chamber;
a liquid supply source;
one or more nozzles in a process chamber and linked to the liquid supply source, for spraying liquid onto the workpiece;
an ozone supply system for providing ozone into the process chamber; and
a photoresist penetrating additive supply for supplying an additive into the liquid provided to the spray nozzles.

14. The system of claim 13 with the additive comprising ammonium hydroxide.

15. The system of claim 13 further comprising a rotor assembly in the chamber for rotating the workpiece.

16. The system of claim 13 further comprising means for controlling the thickness of the liquid layer on the workpiece.
